(19) United States
(12) Patent Application Publication
(10) Pub. No.: US 2014/0055395 A1
(43) Pub. Date: Feb. 27, 2014

(54) METHOD AND APPARATUS FOR CONTROLLING SCROLLING

(71) Applicant: Samsung Electronics Co. Ltd., Suwon-si (KR)

(72) Inventor: Kwang-Ju KIM, Gumi-si (KR)

(73) Assignee: Samsung Electronics Co. Ltd., Suwon-si (KR)

(21) Appl. No.: 13/974,855

(22) Filed: Aug. 23, 2013

(30) Foreign Application Priority Data
Aug. 24, 2012 (KR) 10-2012-0093234

(51) Int. Cl. G06F 3/0485

(52) U.S. Cl. CPC G06F 3/0485
USPC 345/173

(57) ABSTRACT

A method and an apparatus for controlling scrolling are provided. The method includes receiving a proximity input occurring through a proximity event between a screen and an input medium, determining a scrolling direction in view of an area where a touch input has occurred, determining a scrolling speed by using at least one of the area where the touch input has occurred, a time interval during which the touch input is maintained, and a distance between the touch screen and the input medium, and performing the scrolling through a reflection of the scrolling direction and the scrolling speed.

### CROSS-REFERENCE TO RELATED APPLICATION(S)

This application claims the benefit under 35 U.S.C. §119(a) of a Korean patent application filed on Aug. 24, 2012 in the Korean Intellectual Property Office and assigned Serial No. 10-2012-0093234, the entire disclosure of which is hereby incorporated by reference.

### TECHNICAL FIELD

The present disclosure relates to a portable terminal. More particularly, the present disclosure relates to a method and an apparatus for controlling scrolling used for a portable terminal.

### BACKGROUND

Electronic devices of the related art provide more diverse services and optional functions. To improve usefulness of the electronic devices and meet different desires of users, various practical applications have been developed.

The electronic devices may store and run default applications installed therein at a manufacturing stage and optional applications downloaded via the Internet from application sales websites. Optional applications may be developed by general developers and registered in the sales websites. In this respect, anyone may freely develop and sell his/her application through an application sales website to a user of the electronic device. Tens of thousands to hundreds of thousands of free or paid applications are being provided for electronic devices.

Accordingly, at least tens to hundreds of applications are recently stored in the electronic device, such as a smart phone and a tablet Personal Computer (PC), and shortcut keys for executing the respective applications are displayed in an icon form on a touch screen of the electronic device. Thus, a user can execute a desired application through touching any one of the icons displayed on the touch screen in the electronic device.

The electronic device may have a limit in that the application executed in the electronic device displays a large amount of data on a single screen due to a relatively small-sized display. Accordingly, displaying of the data is controlled through a scroll function for displaying a large amount of data, which the application provides, on the display having a limited size. A scroll area is generally set at a restricted location in order to configure the scroll, and the scroll is performed through a touch input on the set area.

### SUMMARY

However, the scroll is performed through the touch input on the restricted area thereby inconveniencing a user.

Therefore, a need exists for a method and an apparatus for controlling scrolling, wherein a user can more conveniently use a scroll function.

The above information is presented as background information only to assist with an understanding of the present disclosure. No determination has been made, and no assertion is made, as to whether any of the above might be applicable as prior art with regard to the present disclosure.

Aspects of the present disclosure are to address at least the above-mentioned problems and/or disadvantages and to provide at least the advantages described below. Accordingly, an aspect of the present disclosure is to provide a method and an apparatus for controlling scrolling, wherein a user can more conveniently use a scroll function.

Another aspect of the present disclosure is to provide a method and an apparatus for controlling scrolling, wherein a user's input is recognized at the whole area of a display including a touch screen so that the scrolling can be controlled.

At least one of the aspects of the present disclosure may be achieved through the elements which will be described below.

In accordance with an aspect of the present disclosure, a method for controlling scrolling of a portable terminal is provided. The method includes receiving a proximity input occurring through a proximity event between a screen and an input medium, determining a scrolling direction in view of an area where a touch input has occurred, determining a scrolling speed by using at least one of the area where the touch input has occurred, a time interval during which the touch input is maintained, and a distance between the touch screen and the input medium, and performing the scrolling through a reflection of the scrolling direction and the scrolling speed.

In accordance with another aspect of the present disclosure, an apparatus for controlling scrolling of a portable terminal is provided. The apparatus includes a proximity event collecting unit configured to receive a proximity input occurring through a proximity event of an input medium from a screen, determine a scrolling direction in view of an area where the proximity input has occurred, and determine a scrolling speed by using at least one of the area where the proximity input has occurred, a time interval during which the proximity input is maintained, and a distance between the screen and the input medium, and a scrolling operating unit configured to perform the scrolling through a reflection of the scrolling direction and the scrolling speed.

As described above, the present disclosure provides a method and an apparatus for controlling scrolling of a portable terminal, which enable a user to more conveniently use a scroll function.

Further, a user can more easily use the scroll function by using the whole display area without restriction, thereby more simply and conveniently controlling an application.

Furthermore, a user can more intuitively use the scroll function in view of a distance from a display and a scrolling operating time, thereby more simply and conveniently controlling the application.

Moreover, a user can more simply and conveniently use the scroll without the repeated contact or drag of a specific area of the touch screen for the scroll.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram illustrating an electronic device according to an embodiment of the present disclosure;

FIG. 2 illustrates a front view of an electronic device according to an embodiment of the present disclosure;

FIG. 3 illustrates a rear view of an electronic device according to an embodiment of the present disclosure;

FIG. 4 is a block diagram illustrating a configuration of a controller of an electronic device to which a method for controlling scrolling is applied according to an embodiment of the present disclosure;

FIG. 5 is a flowchart illustrating an operation of a method for controlling scrolling according to an embodiment of the present disclosure;

FIG. 6 is a flowchart illustrating a process of determining a scrolling direction and a scrolling speed employed for a method for controlling scrolling according to a first embodiment of the present disclosure;

FIGS. 7A and 7B illustrate configurations of a certain area for performing scrolling used in a method for controlling scrolling according to an embodiment of the present disclosure;

FIG. 8 is a flowchart illustrating a process of determining a scrolling direction and a scrolling speed employed for a method for controlling scrolling according to a second embodiment of the present disclosure;

FIGS. 9A and 9B illustrate configurations of a certain area for performing scrolling used in a method for controlling scrolling according to an embodiment of the present disclosure;

FIGS. 10A and 10B are tables illustrating scrolling directions and speeds mapped onto scrolling areas used in a method for controlling scrolling according to an embodiment of the present disclosure;

FIG. 11 is a flowchart illustrating a process of determining a scrolling direction and a scrolling speed employed for a method for controlling scrolling according to a third embodiment of the present disclosure; and

FIGS. 12A and 12B illustrate configurations of a certain area for performing scrolling used in a method for controlling scrolling according to an embodiment of the present disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

The same reference numbers are used throughout the drawings to refer to the same or similar parts. Furthermore, although the drawings represent embodiments of the disclosure, the drawings are not necessarily to scale and certain features may be exaggerated or omitted in order to more clearly illustrate and describe the disclosure.

Among the terms in the disclosure, an electronic device, a terminal, an electronic device, a portable device, and the like, refer to any kind of device capable of processing data which is transmitted or received to or from any external entity. The electronic device, the terminal, the electronic device, the portable device, and the like, may display icons or menus on a screen to which stored data and various executable functions are assigned or mapped. The electronic device, the terminal, the electronic device, the portable device, and the like, may include a computer, a notebook, a tablet Personal Computer (PC), a cellphone, and any known type of electronic device.

Among the terms in the disclosure, a screen refers to a display or other output devices which visually display information to the user, and which optionally may include a touch screen or a touch panel capable of receiving and electronically processing tactile inputs from a user using a stylus, a finger of the user, or other techniques for conveying a user selection from the user to the display or to other output devices.

Among the terms in the disclosure, an icon refers to a graphical element, such as a figure or a symbol displayed on the screen of the electronic device such that a user may easily select a desired function or data. More particularly, each icon has a mapping relation with any function being executable in the electronic device or with any data stored in the electronic device and is used for processing functions or selecting data in the electronic device. When a user selects one of the displayed icons, the electronic device identifies a particular function or data associated with the selected icon. The electronic device executes the identified function or displays the identified data.

Among the terms in the disclosure, data refers to any kind of information processed by the electronic device, including text and/or images received from any external entities, messages transmitted or received, and information created when a specific function is executed by the electronic device.

It will be understood that, although the terms first, second, third, and the like, may be used to describe various elements, components, regions, layers and/or sections, these elements, components, regions, layers and/or sections should not be limited by these terms. These terms are used to distinguish one element, a component, a region, a layer or a section from another region, layer or section. Thus, a first element, a component, a region, a layer or a section may be a second element, a component, a region, a layer or a section without departing from the teachings of the present disclosure. The terminology used in the present disclosure is for the purpose of describing particular embodiments and is not intended to be limiting of the disclosure. The singular forms “a”, “an” and “the” are intended to include the plural forms as well, unless the context clearly indicates otherwise.

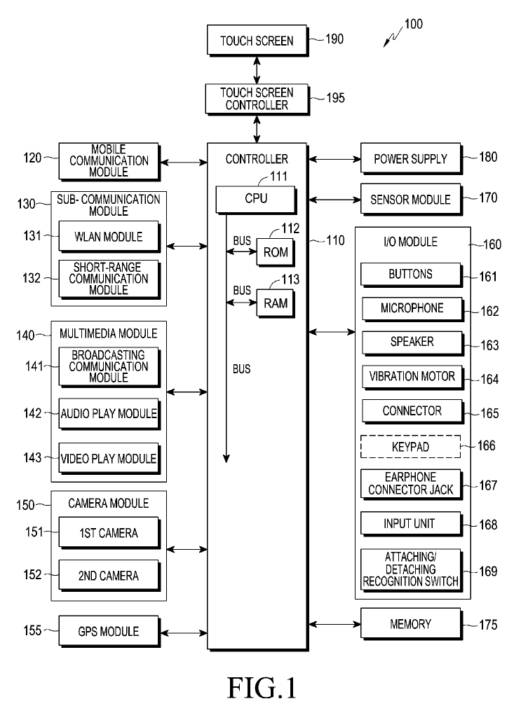

FIG. 1 is a block diagram illustrating an electronic device according to an embodiment of the present disclosure.

Referring to FIG. 1, an electronic device 100 may be connected to an external device by using an external connection device, such as a sub-communication module 130, a connector 165, and an earphone connecting jack 167. The “external device” may include a variety of devices, such as earphones, external speakers, Universal Serial Bus (USB) memories, chargers, cradles/docks, Digital Multimedia Broadcasting (DMB) antennas, electronic payment related devices, health care devices (e.g., blood sugar testers), game consoles, vehicle navigations, and the like, which are removable from the electronic device and connected thereto via a cable. The “external device” may also include a short range communication device that may be wirelessly connected to the electronic device 100 via short range communication, such as BLUETOOTH, a short range wireless communications technology at the 2.4 GHz band, commercially available from the BLUETOOTH SPECIAL INTEREST GROUP, INC., a Near Field Communication (NFC), and the like, and a communication device using WI-FI DIRECT, a wireless technology for data exchange over a computer network, commercially available from the WI-FI ALLIANCE, a wireless Access Point (AP), and the like. Furthermore, the external device may include any other device, such as a cell phone, a smartphone, a tablet PC, a desktop PC, a server, and the like.

Referring to FIG. 1, the electronic device 100 includes a display unit 190 and a display controller 195. The electronic device 100 also includes a controller 110, a mobile communication module 120, the sub-communication module 130, a multimedia module 140, a camera module 150, a Global Positioning System (GPS) module 155, an input/output module 160, a sensor module 170, a storage 175, and a power supply 180. The sub-communication module 130 includes at least one of Wireless Local Area Network (WLAN) 131 and a short-range communication module 132, and the multimedia module 140 includes at least one of a broadcast communication module 141, an audio play module 142, and a video play module 143. The camera module 150 includes at least one of a first camera 151 and a second camera 152, and the input/output module 160 includes at least one of buttons 161, a microphone 162, a speaker 163, a vibration motor 164, the connector 165, and a keypad 166.

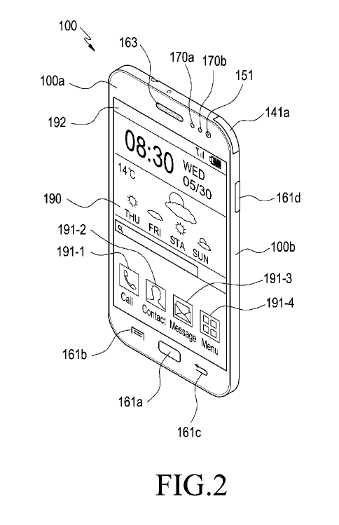

The controller 110 may include a Central Processing Unit (CPU) 111, a Read Only Memory (ROM) 112 for storing a control program, such as an Operating System (OS), to control the electronic device 100, and a Random Access Memory (RAM) 113 for storing signals or data input from an external source or for being used as a memory space for working results in the electronic device 100. The CPU 111 may include a single core, dual cores, triple cores, or quad cores. The CPU 111, ROM 112, and RAM 113 may be connected to each other via an internal bus, which may be represented by the arrows in FIG. 2.

The controller 110 may control the mobile communication module 120, the sub-communication module 130, the multimedia module 140, the camera module 150, the GPS module 155, the input/output module 160, the sensor module 170, the storage 175, the power supply 180, the display unit 190, and the display controller 195.

The mobile communication module 120 connects the electronic device 100 to an external device through mobile communication using at least a one-to-one antenna or a one-to-many antenna under the control of the controller 110. The mobile communication module 120 transmits/receives wireless signals for voice calls, video conference calls, Short Message Service (SMS) messages, or Multimedia Message Service (MMS) messages to/from a cell phone, a smartphone, a tablet PC, or another device, with the phones having phone numbers entered into the electronic device 100.

The sub-communication module 130 may include at least one of the WLAN module 131 and the short-range communication module 132. For example, the sub-communication module 130 may include either the WLAN module 131 or the-short range communication module 132, or both.

The WLAN module 131 may be connected to the Internet in a place where there is a wireless Access Point (AP), under the control of the controller 110. The WLAN module 131 supports the WLAN Institute of Electrical and Electronic Engineers (IEEE)802.11x standard. The short-range communication module 132 may conduct short-range communication between the electronic device 100 and an image rendering device under the control of the controller 110. The short-range communication may include communications compatible with BLUETOOTH, a short range wireless communications technology at the 2.4 GHz band, commercially available from the BLUETOOTH SPECIAL INTEREST GROUP, INC., Infrared Data Association (IrDA), WI-FI DIRECT, a wireless technology for data exchange over a computer network, commercially available from the WI-FI ALLIANCE, NFC, and the like.

The electronic device 100 may include at least one of the mobile communication module 120, the WLAN module 131, and the short-range communication module 132 based on the performance requirements of the electronic device 100. For example, the electronic device 100 may include a combination of the mobile communication module 120, the WLAN module 131, and the short-range communication module 132 based on the performance requirements of the electronic device 100.

The multimedia module 140 may include the broadcast communication module 141, the audio play module 142, or the video play module 143. The broadcast communication module 141 may receive broadcast signals (e.g., television broadcast signals, radio broadcast signals, or data broadcast signals) and additional broadcast information (e.g., an Electric Program Guide (EPG) or an Electric Service Guide (ESG)) transmitted from a broadcasting station through a broadcast communication antenna under the control of the controller 110. The audio play module 142 may play digital audio files (e.g., files having extensions, such as mp3, wma, ogg, or way) stored or received under the control of the controller 110. The video play module 143 may play digital video files (e.g., files having extensions, such as mpeg, mpg, mp4, avi, move, or mkv) stored or received under the control of the controller 110. The video play module 143 may also play digital audio files.

The multimedia module 140 may include the audio play module 142 and the video play module 143 except for the broadcast communication module 141. The audio play module 142 or video play module 143 of the multimedia module 140 may be included in the controller 110.

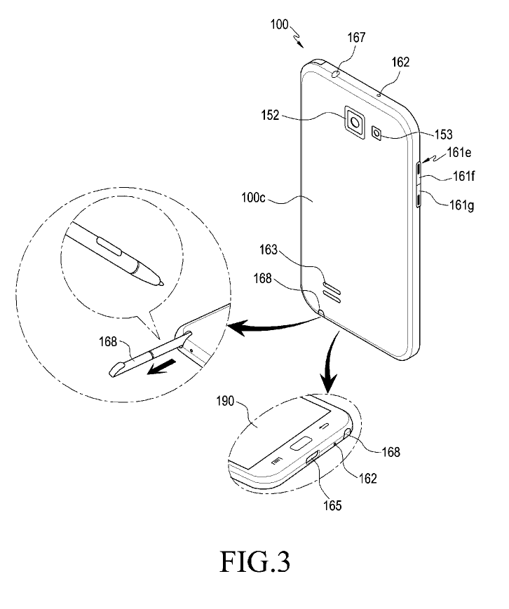

The camera module 150 may include at least one of the first camera 151 and the second camera 152 for capturing still images or video images under the control of the controller 110. Furthermore, the first or second camera 151 or 152, respectively, may include an auxiliary light source (e.g., a flash 153, FIG. 3) for providing an amount of light for capturing an image. The first camera 151 may be placed on the front of the electronic device 100 and the second camera 152 may be placed on the back of electronic device 100. Alternatively, the first and second cameras 151 and 152, respectively, are arranged adjacent to each other (e.g., the distance between the first and second cameras 151 and 152, respectively, may be in the range of 1 cm. to 8 cm.), capturing 3 Dimensional (3D) still images or 3D video images.

The GPS module 155 receives radio signals from a plurality of GPS satellites in orbit around the Earth, and may calculate the position of the electronic device 100 by using time of arrival from the GPS satellites to the electronic device 100.

The input/output module 160 may include at least one of the plurality of buttons 161, the microphone 162, the speaker 163, the vibrating motor 164, the connector 165, and the keypad 166.

The at least one of the buttons 161 may be arranged on the front, side or back of the housing of the electronic device 100, and may include at least one of a power/lock button, a volume button, a menu button, a home button, a back button, and a search button.

The microphone 162 generates electric signals by receiving voice or sound under the control of the controller 110.

The speaker 163 may output sounds externally corresponding to various signals (e.g., radio signals, broadcast signals, digital audio files, digital video files or photography signals) from the mobile communication module 120, sub-communication module 130, multimedia module 140, or camera module 150 under the control of the controller 110. The speaker 163 may output sounds (e.g., button-press sounds or ringback tones) that correspond to functions performed by the electronic device 100. There may be one or multiple speakers 163 arranged in at least one position on or in the housing of the electronic device 100.

The vibrating motor 164 may convert an electric signal to a mechanical vibration under the control of the controller 110. For example, the electronic device 100 in a vibrating mode operates the vibrating motor 164 when receiving a voice call from another device. There may be at least one vibration motor 164 inside the housing of the electronic device 100. The vibration motor 164 may operate in response to a touch activity or continuous touches of a user over the display unit 190.

The connector 165 may be used as an interface for connecting the electronic device 100 to the external device or a power source. Under the control of the controller 110, the electronic device 100 may transmit data stored in the storage 175 of the electronic device 100 to the external device via a cable connected to the connector 165, or receive data from the external device. Furthermore, the electronic device 100 may be powered by the power source via a cable connected to the connector 165 or may charge the battery using the power source.

The keypad 166 may receive key inputs from the user to control the electronic device 100. The keypad 166 includes a mechanical keypad formed in the electronic device 100, or a virtual keypad displayed on the display unit 190. The mechanical keypad formed in the electronic device 100 may optionally be omitted from the implementation of the electronic device 100, depending on the performance requirements or structure of the electronic device 100.

An earphone may be inserted into the earphone connecting jack 167 and thus, may be connected to the electronic device 100.

A stylus pen 168 may be inserted and removably retained in the electronic device 100, and may be drawn out and detached from the electronic device 100.

A pen-removable recognition switch 169 that operates in response to attachment and detachment of the stylus pen 168 is equipped in an area inside the electronic device 100 where the stylus pen 168 is removably retained, and sends a signal that corresponds to the attachment or the detachment of the stylus pen 168 to the controller 100. The pen-removable recognition switch 169 may have a direct or indirect contact with the stylus pen 168 when the stylus pen 168 is inserted into the area. The pen-removable recognition switch 169 generates the signal that corresponds to the attachment or detachment of the stylus pen 168 based on the direct or indirect contact and provides the signal to the controller 110.

The sensor module 170 includes at least one sensor for detecting a status of the electronic device 100. For example, the sensor module 170 may include a proximity sensor for detecting proximity of a user to the electronic device 100, an illumination sensor for detecting an amount of ambient light of the electronic device 100, a motion sensor for detecting the motion of the electronic device 100 (e.g., rotation of the electronic device 100, acceleration or vibration applied to the electronic device 100), a geomagnetic sensor for detecting a point of the compass using the geomagnetic field, a gravity sensor for detecting a direction of gravity, and an altimeter for detecting an altitude by measuring atmospheric pressure. At least one sensor may detect the status and generate a corresponding signal to transmit to the controller 110. The sensor of the sensor module 170 may be added or removed depending on the performance requirements of the electronic device 100 of the electronic device 100.

The storage 175 may store signals or data input/output according to operations of the mobile communication module 120, the sub-communication module 130, the multimedia module 140, the camera module 150, the GPS module, the input/output module 160, the sensor module 170, the display unit 190 under the control of the controller 110. The storage 175 may store the control programs and applications for controlling the electronic device 100 or the controller 110.

The term “storage” refers to the storage 175, and also to the ROM 112, RAM 113 in the controller 110, or a memory card (e.g., a Secure Digital (SD) card, a memory stick, and the like) installed in the electronic device 100. The storage may also include a non-volatile memory, a volatile memory, a Hard Disc Drive (HDD), a Solid State Drive (SSD), or the like.

The power supply 180 may supply power to at least one battery placed inside the housing of the electronic device 100 under the control of the controller 110. The at least one battery powers the electronic device 100. The power supply 180 may supply the electronic device 100 with the power input from the external power source via a cable connected to the connector 165. The power supply 180 may also supply the electronic device 100 with wireless power from an external power source using a wireless charging technology.

The display controller 195 receives information (e.g., information to be generated for making calls, data transmission, broadcast, or photography) that is processed by the controller 110, converts the information to data to be displayed on the display unit 190, and provides the data to the display unit 190. The display unit 190 displays the data received from the display controller 195. For example, in a call mode, the display unit 190 may display a User Interface (UI) or a Graphic User Interface (GUI) with respect to a call. The display unit 190 may include at least one of liquid crystal displays, thin film transistor-liquid crystal displays, organic light-emitting diodes, flexible displays, 3D displays, electrophoretic displays, and the like.

The display unit 190 may be used as an output device and also as an input device, and for the latter case, may have a touchscreen panel to operate as a touch screen. The display unit 190 may send to the display controller 195 an analog signal that corresponds to at least one touch to the UI or GUI. The display unit 190 may detect the at least one touch by a user's physical contact (e.g., by fingers including a thumb) or by a touchable input device (e.g., the stylus pen). The display unit 190 may also receive a dragging movement of a touch among at least one touch and transmit an analog signal that corresponds to the dragging movement to the display controller 195. The display unit 190 may be implemented to detect at least one touch in, for example, a resistive method, a capacitive method, an infrared method, an acoustic wave method, or the like.

The term ‘touches’ are not limited to physical touches by a physical contact of the user or contacts with the touchable input device, but may also include touchless proximity (e.g., maintaining a detectable distance less than 1 mm. between the display unit 190 and the user's body or touchable input device). The detectable distance from the display unit 190 may vary depending on the performance requirements of the electronic device 100 or structure of the electronic device 100, and more particularly, the display unit 190 may output different values (e.g., current values) for touch detection and hovering detection to distinguishably detect that a touch event occurred by a contact with the user's body or the touchable input device and a contactless input (e.g., a hovering event). Furthermore, the display unit 190 may output different values (e.g., current values) for hovering detection over distance from where the hovering event occurs.

The display controller 195 converts the analog signal received from the display unit 190 to a digital signal (e.g., in XY coordinates on the touch panel or display screen) and transmits the digital signal to the controller 110. The controller 110 may control the display unit 190 by using the digital signal received from the display controller 195. For example, in response to the touch event or the hovering event, the controller 110 may enable a shortcut icon displayed on the display unit 190 to be selected or to be executed. The display controller 195 may also be incorporated in the controller 110.

Further, the display controller 195 may determine the distance between where the hovering event occurs and the display unit 190 by detecting a value (e.g., a current value) output through the display unit 190, convert the determined distance to a digital signal (e.g., with a Z coordinate), and provide the digital signal to the controller 110.

Furthermore, depending on implementations, the electronic device 100 may have two or more display units.

The display unit 190 may include at least two touchscreen panels for detecting touches or proximity thereto by the user's body or the touchable input device to receive both inputs by the user's body or the touchable input device simultaneously. The at least two touchscreen panels provide different output values to the display controller 195, and the display controller 195 may differentiate inputs by the user's body and inputs by the touchable input device through the touchscreen by differently recognizing the values input from the at least two touchscreen panels.

FIG. 2 illustrates a front view of an electronic device according to an embodiment of the present disclosure, and FIG. 3 illustrates a rear view of an electronic device according to and embodiment of the present disclosure.

Referring to FIGS. 2 and 3, a front face 100a of the electronic device 100 has the display unit 190 placed in the center, to provide a centrally located screen within the housing and borders of the front face 100a of the electronic device 100. The display unit 190 may be large enough to occupy most of the front face 100a of the electronic device 100. In FIG. 2, the display unit 190 shows an example of displaying a main home screen. The main home screen is a first screen to be displayed on the display unit 190 when the electronic device 100 is turned on or as soon as the screen is unlocked. In a case in which the electronic device 100 has multiple pages of different home screens, the main home screen may be the first or a certain one of the multiple pages of home screens. In the main home screen, shortcut icons 191-1, 191-2, 191-3 for running frequently-used applications, a main menu key 191-4, the time, the weather, and the like, may be displayed. If selected, the main menu key 191-4 displays a menu screen on the display unit 190. In an upper part of the display unit 190, a status bar 192 to display statuses of the electronic device 100, such as a battery charging state, an intensity of received signals, a current time, and the like, may be displayed.

In a lower part of the front face 100a, a home button 161a, a menu button 161b, and a back button 161c may be implemented as physical buttons 161 on or in the housing to the electronic device 100. Alternatively, virtual buttons, such as icons in the screen of the display unit 190, representing the home button 161a, the menu button 161b, and the back button 161c, may be displayed and visually presented instead of or in addition to the physical buttons 161a, 161b, and 161c.

When selected, the home button 161a displays the main home screen on the display unit 190. For example, if the home button 161a is selected while any home screen other than the main home screen or a menu screen is displayed on the display unit 190, the main home screen may be displayed on the display unit 190. Furthermore, while applications are running on the display unit 190, if the home button 161a is selected, the main home screen, as shown in FIG. 2, may be displayed on the display unit 190. The home button 161a may also be used to display recently used applications or a task manager on the display unit 190.

The menu button 161b provides a link menu that may be used on the display unit 190. The link menu may include a widget addition menu, a background change menu, a search menu, an editor menu, an environment setting menu, and the like.

The back button 161c, when touched, may display a screen that was displayed right before a current screen or may stop a most recently used application.

On the edge of the front face 100a of the electronic device 100, the first camera 151, an illumination sensor 170a, and a proximity sensor 170b may be placed. On the back face 100c of the electronic device 100, shown in FIG. 3, the second camera 152, the flash 153, and the speaker 163 may be arranged.

For example, a power/reset button 161d, a volume button 161e (i.e., a volume up button 161f and a volume down button 161g), a terrestrial DMB antenna 141a for reception of broadcasting, and one or a plurality of microphones 162 may be disposed on a lateral side surface 100b of the device 100. The DMB antenna 141a may be fixed to the device 100, or may be formed detachably from the device 100.

A connector 165 is formed on a lower side surface of the device 100. A plurality of electrodes are formed in the connector 165, and may be wiredly connected with the external device. An earphone jack 167 may be formed on an upper side surface of the device 100. Earphones may be inserted into the earphone jack 167.

A stylus pen 168 may be provided on the lower side surface of the device 100. The stylus pen 168 may be inserted into and kept in the device 100, and may be extracted and detached from the device 100 to be detached for use.

The controller 110 included in the electronic device is configured to perform a method for controlling scrolling according to an embodiment of the present disclosure.

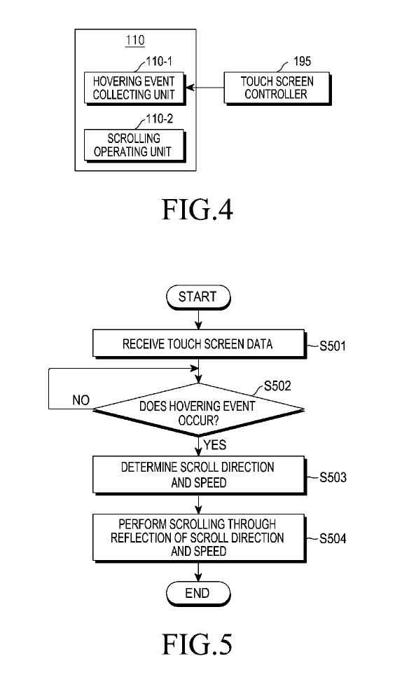

FIG. 4 is a block diagram illustrating a configuration of a controller of an electronic device to which a method for controlling scrolling is applied according to an embodiment of the present disclosure.

Referring to FIG. 4, the controller 110 includes a hovering event collecting unit 110-1 and a scrolling operating unit 110-2, which collect a hovering event and perform an operation to control the scrolling.

The hovering event collecting unit 110-1 may determine whether a hovering event has occurred on the touch screen, by using a digital signal (for example, X, Y, and Z coordinates) provided from the touch screen controller 195, detect an area where the hovering event has occurred, based on the X and Y coordinates, and detect a distance between a user's body or a touchable input unit (for example, the stylus pen 168) and the touch screen 190, based on the Z coordinate. Further, the hovering event collecting unit 110-1 may count a time interval during which the hovering event is maintained at the area where the hovering event has occurred.

The hovering event collecting unit 110-1 determines a direction in which the scrolling will be performed (namely, scrolling direction), by using information on the area where the collected hovering event has occurred.

The scrolling direction may include an upward direction, a downward direction, a leftward direction, a rightward direction, or a stop, and may be determined by using the X and Y coordinates provided from the touch screen controller 195. The determining of the scrolling direction may be performed to determine whether the X and Y coordinates are included within a certain area for the scrolling. For example, it is assumed that a certain area for an upward scrolling is set as an area from a horizontal center line between upper and lower end portions of a display area to an uppermost end of the display area, and a certain area for a downward scrolling is set as an area from the horizontal center line to a lowermost end of the display area. The hovering event collecting unit 110-1 determines the scrolling direction as an upward direction when the X and Y coordinates, provided from the touch screen controller 195, at which the hovering event has occurred are included within the area from the horizontal center line of the display area to the uppermost end of the display area. Further, the hovering event collecting unit 110-1 determines a speed (or acceleration) at which the scrolling will be performed, namely, a scrolling speed (or scrolling acceleration), by using information on the time interval during which the collected hovering event is maintained. The scrolling speed (or acceleration) may be determined by using not only the information on the time interval during which the hovering event is maintained but also a variety of parameters. Specifically, the hovering event collecting unit 110-1 may determine the scrolling speed (or acceleration) by using information on a distance between a location where the hovering event has occurred and the touch screen 190, in which case, for example, the hovering event collecting unit 110-1 may be configured to determine the scrolling speed (or acceleration) as a relatively high speed when the distance between the location where the hovering event has occurred through a user's body or the stylus pen 168 and the touch screen 190 is small, and determine the scrolling speed (or acceleration) as a relatively low speed when the distance between the user's body or the stylus pen 168 and the touch screen 190 is large. Moreover, alternatively, the scrolling speed (or acceleration) may also be determined by using the X and Y coordinates provided from the touch screen controller 195. For example, a touch input area may be divided into a plurality of areas that are set as scrolling areas, respectively, a scrolling direction and a scrolling speed may be mapped onto each of the scrolling areas to be stored in advance, and the hovering event collecting unit 110-1 may determine which of the previously stored areas the X and Y coordinates of the area where the hovering event has occurred correspond to, and determine the scrolling speed as a speed mapped onto the corresponding area.

Further, it is apparent that the scrolling speed (acceleration) may also be determined through a complex combination of at least two of the time interval during which the hovering event is maintained, the distance between the location where the hovering event has occurred and the touch screen 190, and the area where the hovering event has occurred, as described above.

As an alternative to the above-described embodiment of determining the scrolling direction, the hovering event collecting unit 110-1 may determine the scrolling direction in view of an edge area adjacent to an end portion of the touch screen 190. Specifically, the hovering event collecting unit 110-1 may also determine a direction in which the edge area is located as a scrolling direction, when it is determined through the X and Y coordinates provided from the touch screen controller 195 that the area where the hovering event has occurred corresponds to the edge area. Moreover, the hovering event collecting unit 110-1 may also determine the scrolling direction through an additional reflection of information on the time interval during which the hovering event is maintained. For example, the hovering event collecting unit 110-1 may set a first time interval in advance to determine the scrolling direction, and determine the direction in which the edge area is located as a scrolling direction when the hovering event is maintained at the edge area for at least the first time interval.

The hovering event collecting unit 110-1 may also determine the scrolling speed in view of the edge area. Specifically, the hovering event collecting unit 110-1 may set a second time interval in advance to determine the scrolling speed, determine the scrolling speed as a first speed after a hovering event is maintained at the edge area for at least the second time interval, and set the scrolling speed to zero such that scrolling is not performed, until the time interval during which the hovering event is maintained reaches the second time interval. Here, the first and second time intervals may be set identically with each other or differently from each other.

The scrolling operating unit 110-2 performs the scrolling by using the scrolling direction and the scrolling speed (acceleration), which have been determined by the hovering event collecting unit 110-1.

The above-described controller 110 may be configured to realize embodiments of a method for controlling scrolling which will be described below, in which it is apparent that the controller 110 may variously apply not only the configuration and the operation of the embodiment which have been described above but also the embodiments of the method for controlling the scrolling which will be described below.

FIG. 5 is a flowchart illustrating an operation of a method for controlling scrolling according to an embodiment of the present disclosure.

Referring to FIG. 5, the operation of the method for controlling the scrolling may be performed by a controller 110, and more particularly, may be performed through a reflection of a value that is received from a touch screen controller 195.

The operation of the method for controlling the scrolling is started by a signal input from the touch screen controller. For example, the operation of the method for controlling the scrolling is started as the controller receives data (for example, a digital signal for X, Y, and Z coordinates of a touch input), which has been generated in correspondence to close access of a user's body or a stylus pen 168, from the touch screen controller in operation 5501.

Thereafter, in operation 5502, the controller identifies a value (for example, Z coordinate) that indicates a distance between the user's body or the stylus pen 168 and a touch screen 190, among the received data (for example, the digital signal for the X, Y, and Z coordinates of the touch input) in operation 5501, and determines whether the value indicating the distance exceeds a threshold value for a hovering event.

When the controller determines in operation 5502 that the hovering event has occurred, the controller performs, in operation 5503, when the value indicating the distance exceeds the threshold value for the hovering event. On the other hand, when the controller determines in operation 5502 that the hovering event has not occurred, the controller returns to operation 5501 and identifies data received from the touch screen controller, when the value indicating the distance does not exceed the threshold value for the hovering event.

Meanwhile, in operation 5503, the controller determines a direction in which the scrolling will be performed and a speed (or acceleration) at which the scrolling will be performed, by using the received data (for example, the digital signal for X, Y, and Z coordinates of the hovering input) in operation 5501. Specifically, the controller identifies the data for the area where the hovering event has occurred, among the received data (for example, the digital signal for the X, Y, and Z coordinates of the hovering input) in operation 5501. For example, the controller identifies the data for the X and Y coordinates of the hovering input, and determines an area where the hover event has occurred. The controller determines the direction in which the scrolling will be performed, by using the area where the hovering event has occurred. For example, the controller determines the scrolling direction as an upward direction when the area where the hovering event has occurred is located at an upper portion with respect to a display screen, and determines the scrolling direction as a downward direction when the area where the hovering event has occurred is located at a lower portion with respect to the display screen.

The scrolling speed (or acceleration) may be determined through various applications of a time interval during which the hovering event is maintained on the touch screen, a distance by which the hovering event has occurred, and an area where the hovering event has occurred on the touch screen.

In operation S504, the controller performs the scrolling based on the determined direction and speed (or acceleration) in operation S503. The scrolling is maintained until the hovering event is completed, and a hovering variation of the user's body or the touchable input unit is reflected in the scrolling direction and speed (or acceleration) in real time.

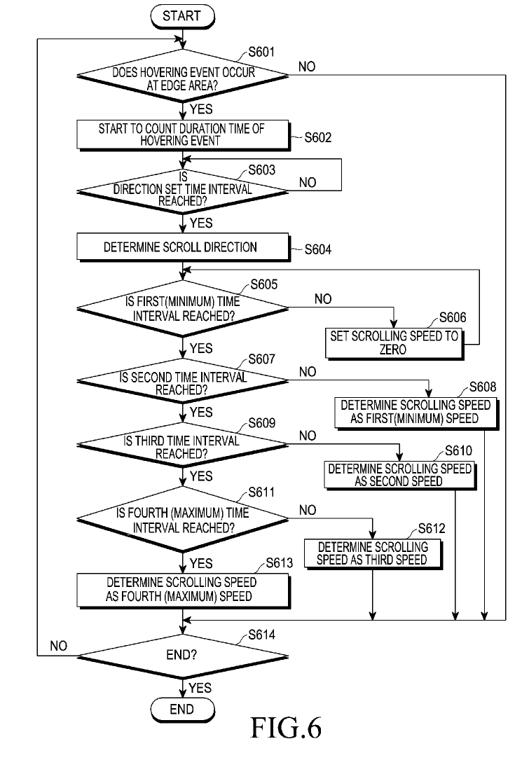

FIG. 6 is a flowchart illustrating a process of determining a scrolling direction and a scrolling speed employed for a method for controlling scrolling according to a first embodiment of the present disclosure.

Referring to FIG. 6, in operation S601, a controller determines whether an area where a hovering event has occurred corresponds to an edge area that is set in advance for performing the scrolling. The controller performs operation S602 when the area where the hovering event has occurred corresponds to the edge area set in advance for performing the scrolling (operation S601—Yes), and performs operation S614 when the area where the hovering event has occurred does not correspond to the edge area set in advance for performing the scrolling (operation S601—No).

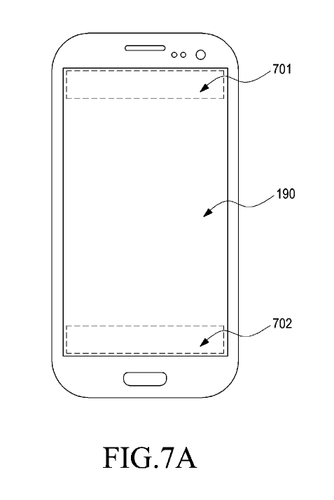

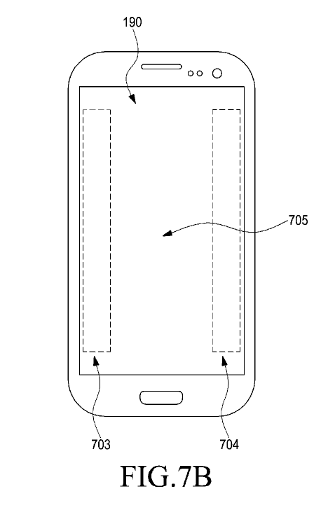

FIGS. 7A and 7B illustrate configurations of a certain area for performing scrolling used in a method for controlling scrolling according to an embodiment of the present disclosure.

Referring to FIG. 7A, the controller determines whether a hovering event has occurred at a first edge area 701 that is set in advance for performing scrolling upward, or at a second edge area 702 that is set in advance for performing scrolling downward.

Referring to FIG. 7B, the controller may similarly further determine whether a hovering event has occurred at a third edge area 703 that is set in advance for performing scrolling leftward, or at a fourth edge area 704 that is set in advance for performing scrolling rightward.

On the other hand, referring back to FIG. 6, the controller determines that the hovering event has not occurred at the edge area and performs operation S614, when the hovering event has occurred at a fifth area 705 but not at the first to fourth areas 701, 702, 703, and 704 (operation S601—No).

The first edge area 701 may correspond to an area from an uppermost end portion of a display area to a point spaced a certain distance (for example, 1 cm) apart from the uppermost end portion, the second edge area 702 may correspond to an area from a lowermost end portion of the display area to a point spaced a certain distance (for example, 1 cm) apart from the lowermost end portion, the third edge area 703 may correspond to an area from a leftmost end portion of the display area to a point spaced a certain distance (for example, 1 cm) apart from the leftmost end portion, and the fourth edge area 704 may correspond to an area from a rightmost end portion of the display area to a point spaced a certain distance (for example, 1 cm) apart from the rightmost end portion.

Thereafter, the controller starts to count a duration time interval of the hovering event in order to identify a time interval during which the hovering event is maintained at the edge area, in operation S602.

The duration time interval of the hovering event may be reflected in determination of the scrolling direction. For example, the controller may set a direction set time interval in advance on behalf of a time interval for determining the scrolling direction, and determine a direction corresponding to the edge area as a scrolling direction when the hovering event is maintained at the edge area for at least the direction set time interval. To this end, the controller identifies the counted time interval, and determines whether the time interval during which the hovering event is maintained at the edge area is greater than the direction set time interval, in operation S603. The controller determines the direction corresponding to the edge area as a scrolling direction, when the time interval during which the hovering event is maintained at the edge area is greater than the direction set time interval, in operation S604.

Further, operation S603 may be excluded. For example, the controller may identify the edge area where the hovering event has occurred, and determine a direction corresponding to the edge area as a scrolling direction, by performing operation S604 irrespective of the duration time interval of the hovering event after operation S602.

The controller performs an operation to determine the scrolling speed after the scrolling direction is determined through the above-described operation. For example, the controller determines whether the time interval during which the hovering event is maintained reaches a first time interval set in advance for performing scrolling, in operation S605. The controller sets the scrolling speed to zero in operation S606 until the time interval during which the hovering event is maintained reaches the first time interval set in advance for performing the scrolling (operation S605—No), and performs a next operation, namely, operation S607 when the time interval during which the hovering event is maintained reaches the first time interval set in advance for performing the scrolling (operation S605—Yes).

The first time interval set in advance for performing the scrolling is a minimum time interval that is set for performing the scrolling, and is a time interval that is set for performing the scrolling at a first speed (or acceleration). In the following description, second, third, and fourth time intervals for performing the scrolling sequentially have larger values, respectively, and are time intervals that are set for performing the scrolling at a second speed (or acceleration), a third speed (or acceleration), and a fourth speed (or acceleration), respectively. Accordingly, the second time interval has a large value relative to the first time interval, the third time interval has a large value relative to the second time interval, and the fourth time interval has a large value relative to the third time interval. The third speed (or acceleration) is higher than the second speed (or acceleration), and the fourth speed (or acceleration) is higher than the third speed (or acceleration). Further, the fourth speed (or acceleration) is set to a maximum speed set in advance for performing the scrolling, and the controller may be configured to perform the scrolling by applying the fourth speed (or acceleration) to all hovering inputs duration time intervals of which exceed the fourth time interval.

In operation S607, the controller maintains the scrolling speed at the first speed (or acceleration) in operation S608, until the time interval during which the hovering event is maintained reaches the second time interval set in advance for performing the scrolling (operation S607—No), and performs operation S609 when the time interval during which the hovering event is maintained reaches the second time interval set in advance for performing the scrolling (operation S607—Yes).

In operation S609 likewise to operation S607 and operation S608, the controller maintains the scrolling speed at the second speed (or acceleration) in operation S610, until the time interval during which the hovering event is maintained reaches the third time set in advance interval for performing the scrolling (operation S609—No), and performs operation S611 when the time interval during which the hovering event is maintained reaches the third time interval set in advance for performing the scrolling (operation S609—Yes).

Even in operation S611, the controller maintains the scrolling speed at the third speed (or acceleration) in operation S612, until the time interval during which the hovering event is maintained reaches the fourth time interval set in advance for performing the scrolling (operation S611—No), and performs operation S613 when the time interval during which the hovering event is maintained reaches the fourth time interval set in advance for performing the scrolling (operation S611—Yes).

Meanwhile, in operation S613, the controller determines the scrolling speed as the maximum speed (the fourth speed) set in advance for performing the scrolling. In operation S614, the controller determines whether the hovering event is completed, and determines whether to repeat or complete the operation of determining the scrolling direction and speed used to perform the scrolling.

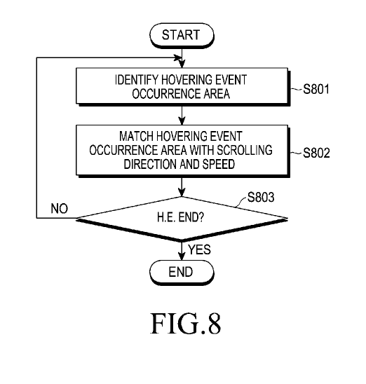

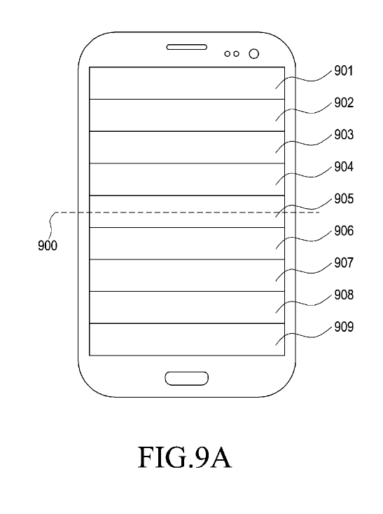

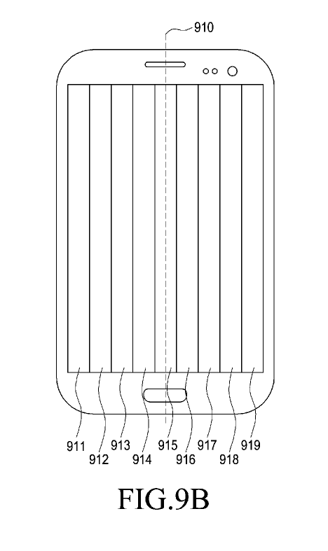

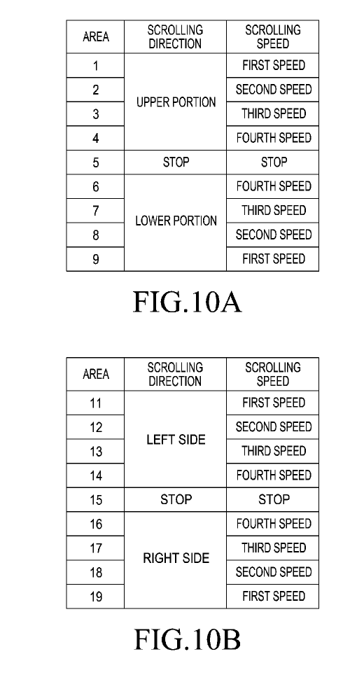

FIG. 8 is a flowchart illustrating a process of determining a scrolling direction and a scrolling speed employed for a method for controlling scrolling according to a second embodiment of the present disclosure. FIGS. 9A and 9B illustrate configurations of a certain area for performing scrolling used in a method for controlling scrolling according to an embodiment of the present disclosure. FIGS. 10A and 10B are tables illustrating scrolling directions and speeds mapped onto scrolling areas used in a method for controlling scrolling according to an embodiment of the present disclosure.

Referring to FIG. 8, a controller identifies an area where a hovering event has occurred, through data for X and Y coordinates of a hovering input in operation S801, and determines a scrolling direction and a scrolling speed, corresponding to the area where the hovering event has occurred, by matching the area where the hovering event has occurred with a certain scrolling direction and a certain scrolling speed, in operation S802. In operation S803, the controller determines whether the hovering event is completed, and determines whether to repeat or complete the operation of determining the scrolling direction and speed used to perform the scrolling.

Referring to FIGS. 9A and 10A, a touch input area may be divided into a plurality of areas that are set as scrolling areas, respectively, as illustrated in FIG. 9A. A scrolling direction and a scrolling speed are mapped onto each of the set scrolling areas to be stored in advance, as illustrated in FIG. 10A. For example, the controller sets the scrolling direction as an upward direction, and the scrolling speed as a first speed, when a hovering event has occurred at a first area 901. The controller similarly sets the scrolling direction as an upward direction, and sets the scrolling speeds as second, third, and fourth speeds, respectively, when hovering events occur at second, third, and fourth areas 902, 903, and 904, respectively. Relationships between the first, second, third, and fourth speeds are represented by Inequality 1 below. The first speed is the highest speed, and the second, third, and fourth speeds may be set in a descending order. Accordingly, scrolling may be more rapidly performed upward when the hovering event occurs at the first area than when the hovering event occurs at the second area.

V₁>V₂>V₃>V₄. Inequality 1

In Inequality 1 above, V₁ denotes the first speed, V₂ denotes the second speed, V₃ denotes the third speed, and V₄ denotes the fourth speed.

The scrolling direction and the scrolling speed are set to be stopped at a fifth area 905. Accordingly, scrolling is maintained in a stopped state when a hovering event occurs at the fifth area 905. The fifth area 905 corresponds to an area located at a horizontal central portion of the touch input area, and may include a horizontal center line 900.

Further, the controller sets the scrolling direction as a downward direction, and sets the scrolling speeds as the fourth, third, second, and first speeds, respectively, when hovering events occur at sixth, seventh, eighth, and ninth areas 906, 907, 908, and 909, respectively. At this time, relationships between the first, second, third, and fourth speeds are represented by Inequality 1 above. Accordingly, scrolling may be more rapidly performed downward when the hovering event occurs at the eighth area 908 than when the hovering event occurs at the seventh area 907, and on the other hand, scrolling may be more slowly performed downward when the hovering event occurs at the sixth area 906 than when the hovering event occurs at the seventh area 907.

Although the upward scrolling and the downward scrolling have been illustrated in the above-described embodiments, the present disclosure is not limited thereto, and leftward scrolling and rightward scrolling may also be performed in the same manner.

Referring to FIGS. 9B and 10B, a hovering input area may be divided into a plurality of areas that are set as scrolling areas, respectively, as illustrated in FIG. 9B. A scrolling direction and a scrolling speed are mapped onto each of the set scrolling areas to be stored in advance, as illustrated in FIG. 10B. For example, the controller sets the scrolling direction as a leftward direction, and sets the scrolling speed as a first speed, when a hovering event has occurred at an eleventh area 911. The controller similarly sets the scrolling direction as a leftward direction, and sets the scrolling speeds as second, third, and fourth speeds, respectively, when hovering events occur at twelfth, thirteenth, and fourteenth areas 912, 913, and 914, respectively. Relationships between the first, second, third, and fourth speeds are represented by Inequality 1 above. The first speed is the highest speed, and the second, third, and fourth speeds may be set in a descending order.

The scrolling direction and the scrolling speed are set to be stopped at a fifteenth area 915. Accordingly, scrolling is maintained in a stopped state when a hovering event occurs at the fifteenth area 915. The fifteenth area 915 corresponds to an area located at a vertical central portion of the hovering input area, and may include a vertical center line 910.

Further, the controller sets the scrolling direction as a rightward direction, and sets the scrolling speeds as the fourth, third, second, and first speeds, respectively, when hovering events occur at sixteenth, seventeenth, eighteenth, and nineteenth areas 916, 917, 918, and 919, respectively. At this time, relationships between the first, second, third, and fourth speeds are represented by Inequality 1 above. Accordingly, scrolling may be more rapidly performed rightward when the hovering event occurs at the eighteenth area 918 than when the hovering event occurs at the seventeenth area 917. On the other hand, scrolling may be more slowly performed rightward when the hovering event occurs at the sixteenth area 916 than when the hovering event occurs at the seventeenth area 917.

In the above-described second embodiment of the process of determining the scrolling direction and the scrolling speed, a mode in which the scrolling direction is determined as the upward or downward direction (hereinafter, referred to as a up-down mode), and a mode in which the scrolling direction is determined as the leftward or rightward direction (hereinafter, referred to as a left-right mode) have been illustrated. The mode of the scrolling direction may be determined in view of a direction in which the currently displayed data is arranged, and the process of determining the scrolling direction and speed may further include a process (not illustrated) of determining the mode of the scrolling direction. In the process of determining the mode of the scrolling direction, the mode of the scrolling direction may be determined as the up-down mode illustrated in FIGS. 9A and 10A when the currently displayed data is arranged upward and downward, and may be determined as the left-right mode illustrated in FIGS. 9B and 10B when the currently displayed data is arranged leftward and rightward. Further, the process of determining the mode of the scrolling direction may be applied through a reflection of various factors, such as a form of data displayed through an application (a photograph, a moving image, a text, or the like), and a direction of a display screen (a vertical direction, a horizontal direction, or the like).

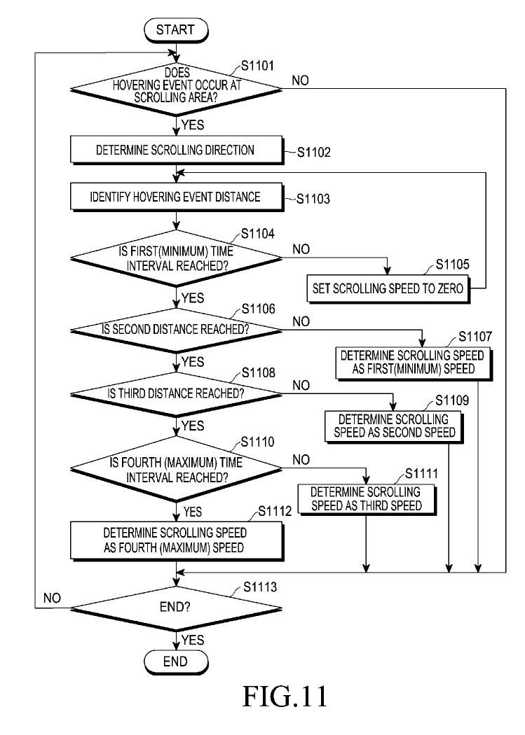

FIG. 11 is a flowchart illustrating a process of determining a scrolling direction and a scrolling speed employed for a method for controlling scrolling according to a third embodiment of the present disclosure.

Referring to FIG. 11, at operation S1101, a controller determines whether an area where a hovering event has occurred corresponds to an area that is set in advance for performing the scrolling. The controller performs operation S1102 of determining the scrolling direction when the area where the hovering event has occurred corresponds to the area set in advance for performing the scrolling (operation S 1101—Yes), and performs operation S1113 when the area where the hovering event has occurred does not correspond to the area set in advance for performing the scrolling (operation S1101—No).

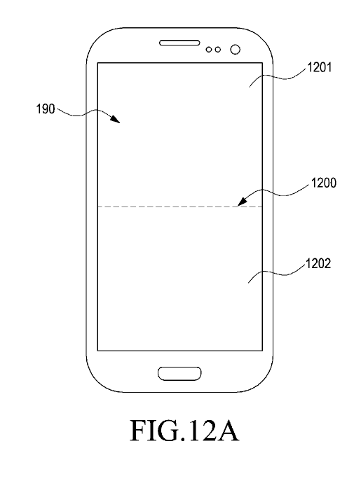

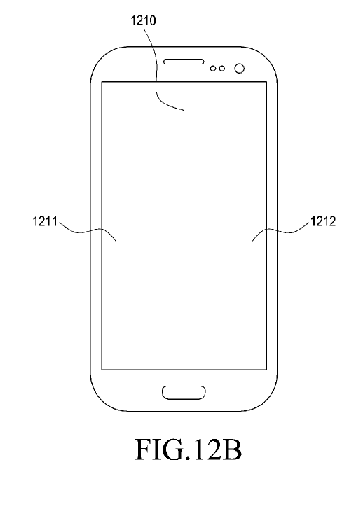

FIGS. 12A and 12B illustrate configurations of a certain area for performing scrolling used in a method for controlling scrolling according to an embodiment of the present disclosure.

Referring to FIG. 12A, the controller performs operation S1102 to determine the direction in which the scrolling will be performed as an upward direction, when a hovering event has occurred at a first area 1201 set in advance for performing the scrolling upward, or performs operation S1102 to determine the direction in which the scrolling will be performed as a downward direction, when a hovering event has occurred at a second area 1202 set in advance for performing the scrolling downward.

The first area 1201 corresponds to an area between a horizontal center line 1200 and an uppermost end of a display area, and the second area 1202 corresponds to an area between the horizontal center line 1200 and a lowermost end of the display area.

Although the scrolling performed upward or downward has been illustrated in the embodiment of the present disclosure, the present disclosure is not limited thereto. For example, the scrolling may also be further performed leftward or rightward in addition to upward or downward.

Referring to FIG. 12B, certain areas are set and the controller may perform operation S1102 to determine the direction in which the scrolling will be performed as a leftward direction when a hovering event has occurred at a third area 1211 set in advance, and perform operation S1102 to determine the direction in which the scrolling will be performed as a rightward direction when a hovering event has occurred at a fourth area 1212 set in advance. Here, the third area 1211 corresponds to an area between a vertical center line 1210 and a leftmost end of a display area, and the fourth area 1212 corresponds to an area between the vertical center line 1210 and a rightmost end of the display area.

In the above-described third embodiment of the process of determining the scrolling direction and the scrolling speed, a mode in which the scrolling direction is determined as the upward or downward direction (hereinafter, referred to as a up-down mode), and a mode in which the scrolling direction is determined as the leftward or rightward direction (hereinafter, referred to as a left-right mode) have been illustrated. The mode of the scrolling direction may be determined in view of a direction in which the currently displayed data is arranged, and the process of determining the scrolling direction may further include a process (not illustrated) of determining the mode of the scrolling direction. In the process of determining the mode of the scrolling direction, the mode of the scrolling direction may be determined as the up-down mode illustrated in FIG. 12A when the currently displayed data is arranged upward and downward, and the mode of the scrolling direction may be determined as the left-right mode illustrated in FIG. 12B when the currently displayed data is arranged leftward and rightward. Further, the process of determining the mode of the scrolling direction may be applied through a reflection of various factors, such as a form of data displayed through an application (a photograph, a moving image, a text, or the like), and a direction of a display screen (a vertical direction, a horizontal direction, or the like).

Thereafter, in operation S1103, the controller identifies a distance by which the hovering event has occurred at the area identified in operation S1102, that is, a distance between a user's body or a touchable input unit and a touch screen.

In operation S1104, the controller determines whether the distance by which the hovering event has occurred reaches a first distance set in advance for performing scrolling. The controller sets the scrolling speed to zero in operation S1105 until the distance by which the hovering event has occurred reaches the first distance set in advance for performing the scrolling (operation S1104—No), and performs a next operation, namely, operation S1106 when the distance by which the hovering event has occurred reaches the first distance set in advance for performing the scrolling (operation S1104—Yes).

The first distance set in advance for performing the scrolling is a minimum distance that is set for performing the scrolling, and is a distance that is set for performing the scrolling at a first speed (or acceleration). In the following description, second, third, and fourth distances for performing the scrolling sequentially have larger distance values, respectively, and are distances that are set for performing the scrolling at a second speed (or acceleration), a third speed (or acceleration), and a fourth speed (or acceleration), respectively. Accordingly, the second distance has a large value relative to the first distance, the third distance has a large value relative to the second distance, and the fourth distance has a large value relative to the third distance. The third speed (or acceleration) may be set to a speed higher than the second speed (or acceleration), and the fourth speed (or acceleration) may be set to a speed higher than the third speed (or acceleration). Further, the fourth speed (or acceleration) is set to a maximum speed set in advance for performing the scrolling, and the controller may be configured to perform the scrolling by applying the fourth speed (or acceleration) to all hovering inputs hovering distances of which exceed the fourth distance.

The controller performs operation S1108 when the distance by which the hovering event has occurred reaches the second distance set in advance for performing the scrolling (operation S1106—Yes), and determines the speed at which the scrolling will be performed as the first speed (acceleration) in operation S1107 when the distance by which the hovering event has occurred does not reach the second distance set in advance for performing the scrolling (operation S1106—No).

The controller performs operation S1110 when the distance by which the hovering event has occurred reaches the third distance set in advance for performing the scrolling (operation S1108—Yes), and determines the speed at which the scrolling will be performed as the second speed (acceleration) in operation S1109 when the distance by which the hovering event has occurred does not reach the third distance set in advance for performing the scrolling (operation S1108—No).

The controller performs operation S1112 when the distance by which the hovering event has occurred reaches the fourth distance set in advance for performing the scrolling (operation S1110—Yes), and determines the speed at which the scrolling will be performed as the third speed (acceleration) in operation S1111 when the distance by which the hovering event has occurred does not reach the fourth distance set in advance for performing the scrolling (operation S1110—No).

Meanwhile, in operation S1112, the controller determines the scrolling speed as the maximum speed (the fourth speed) set in advance for performing the scrolling. In operation S1113, the controller determines whether the hovering event is completed, and determines whether to repeat or complete the operation of determining the scrolling direction and speed used to perform the scrolling.

According to the present disclosure described above, a user can more conveniently use a scroll function. Further, a user can more easily use the scroll function by using the whole display area without restriction, thereby more simply and conveniently controlling the application.

Furthermore, a user can more intuitively use the scroll function in view of the distance from the display and the scrolling operating time, thereby more simply and conveniently controlling the application.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a ROM, a RAM, CD-ROMs, magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the embodiments of the present disclosure as described above typically involve the processing of input data and the generation of output data to some extent. This input data processing and output data generation may be implemented in hardware or software in combination with hardware. For example, specific electronic components may be employed in an electronic device or similar or related circuitry for implementing the functions associated with the embodiments of the present disclosure as described above. Alternatively, one or more processors operating in accordance with stored instructions may implement the functions associated with the embodiments of the present disclosure as described above. If such is the case, it is within the scope of the present disclosure that such instructions may be stored on one or more non-transitory processor readable mediums. Examples of the processor readable mediums include a ROM, a RAM, a Compact Disc (CD)-ROM, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for controlling scrolling of a portable terminal, the method comprising:
receiving a proximity input occurring through a proximity event between a screen and an input medium;
determining a scrolling direction in view of an area where a touch input has occurred;
determining a scrolling speed by using at least one of the area where the touch input has occurred, a time interval during which the touch input is maintained, and a distance between the touch screen and the input medium; and
performing the scrolling through a reflection of the scrolling direction and the scrolling speed.

2. The method of claim 1, wherein the proximity input comprises a hovering input caused as the input medium closely accesses the screen.

3. The method of claim 1, wherein the input medium comprises at least one of a user's finger and a stylus pen.

4. The method of claim 3, wherein the receiving of the proximity input comprises identifying the input medium as the user's finger or the stylus pen.

5. The method of claim 1, wherein the determining of the scrolling direction comprises determining a direction in which an edge area is located as the scrolling direction, when the area where the proximity input has occurred includes the edge area of the touch screen.

6. The method of claim 5, wherein the determining of the scrolling direction further comprises determining the scrolling direction in correspondence to an occurrence of the proximity input over the edge area for at least a first time interval.

7. The method of claim 5, wherein the determining of the scrolling speed comprises determining the scrolling speed in correspondence to an occurrence of the proximity input over the edge area for at least a second time interval.

8. The method of claim 7, wherein the determining of the scrolling speed further comprises determining the scrolling speed as zero until the second time interval is reached while the proximity input is maintained over the edge area.

9. The method of claim 1, wherein the determining of the scrolling speed comprises setting the scrolling speed to a higher speed, as a distance by which the proximity input has occurred decreases.

10. The method of claim 9, wherein the determining of the scrolling speed further comprises determining the scrolling speed as zero when the distance by which the proximity input has occurred exceeds a first distance.

11. The method of claim 1, wherein the determining of the scrolling speed comprises setting the scrolling speed to a higher speed, as the time interval during which the proximity input is maintained increases.

12. The method of claim 1, wherein the determining of the scrolling speed comprises setting the scrolling speed to a higher speed, as the area where the proximity input has occurred is closer to an end portion of the screen.

13. The method of claim 12, wherein the determining of the scrolling speed further comprises setting the scrolling speed to zero when the proximity input occurs at a first area comprising a center line that equally divides an area between opposite end portions of the screen.

14. The method of claim 13, wherein the performing of the scrolling comprises stopping the scrolling as the scrolling speed is determined as zero.

15. An apparatus for controlling scrolling of a portable terminal, the apparatus comprising;
a proximity event collecting unit configured to receive a proximity input occurring through a proximity event of an input medium from a screen, determine a scrolling direction in view of an area where the proximity input has occurred, and determine a scrolling speed by using at least one of the area where the proximity input has occurred, a time interval during which the proximity input is maintained, and a distance between the screen and the input medium; and
a scrolling operating unit configured to perform the scrolling through a reflection of the scrolling direction and the scrolling speed.

16. A non-transitory processor readable medium for storing a computer program of instructions configured to be readable by at least one processor for instructing the at least one processor to execute a computer process for performing the method as recited in claim 1.
